(19) United States
(12) Patent Application Publication
(10) Pub. No.: US 2012/0196496 A1
(43) Pub. Date: Aug. 2, 2012

(54) SLIP RESISTANT SHEET MATERIAL FOR ROOFING

(75) Inventors: David Granovsky, Toronto (CA); Pascal Risler, Boucherville (CA)

(73) Assignee: Atlantic Coated Papers Ltd., Toronto (CA)

(21) Appl. No.: 13/362,473

(22) Filed: Jan. 31, 2012

Related U.S. Application Data
(60) Provisional application No. 61/437,955, filed on Jan. 31, 2011.

(51) Int. Cl. D03D 15/00; C09J 5/00

(52) U.S. Cl. 442/189; 139/11; 139/420 R; 156/324

(57) ABSTRACT

The present document describes a slip resistant sheet material for roofing comprising a closed-weave woven comprising yarns of a first gauge and yarns of a second gauge greater than the first gauge. The yarns of the second gauge are interspersed in the closed-weave woven at a given interval with the yarns of the first gauge.

### CROSS-REFERENCE TO RELATED APPLICATIONS

This application claims priority under 35 USC §119(e) of U.S. provisional patent application 61/437,955, filed on Jan. 31, 2011, the specification of which is hereby incorporated by reference.

### BACKGROUND

(a) Field

The subject matter disclosed generally relates to a weather-resistive barrier for a roofing structure, and especially to a reinforced roof underlayment having a slip resistant feature.

(b) Related Prior Art

Roofing structures for buildings typically include an underlayment positioned between a roof support deck and an overlayment. The overlayment, such as asphalt shingles, tiles, wooden shakes, slate tiles metal roofing, or the like is intended to provide protection from external weather conditions like wind, rainwater, and snowmelt. In order to further protect against moisture and other elements which may pass under the overlayment, the underlayment is installed over the roof deck and under the underlayment to provide an added waterproof barrier. The additional moisture protection provided by the underlayment is particularly necessary with tile roofs, where gaps often exist between the tiles where moisture can pass through. The underlayment also serves the function of providing a seal around roofing fasteners used to affix the tiles to the roof support deck.

Underlayments have conventionally been produced by coating a layer of organic paper with a certain density of asphalt. Over time, the underlayment is exposed to moisture and other external elements which gather underneath the overlayment. This exposure to external elements causes the organic paper-based underlayments to deteriorate over time, especially in tile roofs where gaps between the tiles can expose the underlayment to larger amounts of external elements. Furthermore, constant exposure to sunlight coupled with heat rising from within the building often results in the roofing structure being exposed to high temperatures which can dry out and further deteriorate the underlayment. The deterioration of the underlayment allows moisture to pass through the underlayment and leak through the roof structure, resulting in damage to the interior of the building. The integrity of the roof structure is often dependent upon the very effectiveness of the underlayment. In attempting to utilize existing organic paper-based underlayment in tile roofs, it has been found that the underlayments deteriorate much more quickly than the tile overlayment. Thus, the effectiveness of the waterproof barrier provided by the roofing structure is often limited to the life of the underlayment.

Another problem with existing underlayment being formed from an organic, paper-based material is that the underlayments are flexible and require a solid support structure beneath them. When these organic paper-based underlayments are used with spaced support structures, such as spaced rafters, the underlayment will drape between the rafters to which the underlayment is attached. When moisture gathers underneath the overlayment, it will tend to congregate in the draped portions of the underlayment between the rafters. This moisture creates tension on the underlayment in the draped portions as well as the points on underlayment where it is attached to the rafters, where it has been found that the organic paper-based underlayment tend to tear when the tension becomes too great in these locations from excess moisture accumulating. The resistance of the overlayment to tearing is further weakened by the above-described deterioration of the underlayment over time. Thus, organic underlayments have been found to be ineffective in providing a waterproof barrier when used with non-solid support structures.

There is a clearly need for a roofing underlayment having an improved resistance to deterioration from exposure to external elements which prevents a person from slipping while moving about on the roofing underlayment. Moreover, there is a need for a tear-resistant roofing underlayment having an improved longevity which closely matches that of the overlayment.

### SUMMARY

According to an embodiment, there is provided a slip resistant sheet material for roofing comprising a closed-weave woven. The closed-weave woven comprises yarns of a first gauge and yarns of a second gauge greater than the first gauge. The yarns of the second gauge are interspersed in the closed-weave woven at a given interval with the yarns of the first gauge. A difference in size between the yarns of the first gauge and the yarns of the second gauge provides slip resistance.

According to another embodiment, the yarns of the second gauge are parallel to each other.

According to another embodiment, the spacing between the parallel yarns of the second gauge is substantially equal.

According to another embodiment, the yarns of the first gauge are organized in a first group in a first direction and in a second group in a second direction perpendicular to the first direction.

According to another embodiment, yarns of the second gauge are interspersed at the given interval in one of the first and second groups.

According to another embodiment, all yarns of the second gauge are interspersed at the given interval in one of the first and second groups.

According to another embodiment, the given interval is a multiple of 6 yarns.

According to another embodiment, the given interval is a multiple of 18 yarns.

According to another embodiment, the given interval is a multiple of one of: 6 yarns, 18 yarns, 36 yarns, 72 yarns and 90 yarns.

According to another embodiment, the given interval is a mix of at least two given intervals.

According to another embodiment, the given interval is one of: a regular given interval and an irregular given interval.

According to another embodiment, the closed-weave woven comprises a front side and a back side and the slip resistant sheet material further comprises at least one thermoplastic layer respectively affixed to at least one of the front side and the back side of the closed-weave woven for providing a weather-resistant barrier.

According to another embodiment, the at least one thermoplastic layer is a film-forming polymer.

According to another embodiment, the at least one thermoplastic layer may include polyethylene or polypropylene.

According to another embodiment, the yarns of a first gauge comprise a size approximately from about 800 Denier to about 1,000 Denier.

According to another embodiment, the yarns of a second gauge comprise a size approximately from about 1,000 Denier to about 1,200 Denier.

According to another embodiment, the yarns of a first gauge are substantially flat.

According to another embodiment, there is provided a method for making a slip resistant sheet material for roofing. The method comprising during weaving of a closed-weave woven comprising yarns of a first gauge, interspersing yarns of a second gauge at a given interval with the yarns of the first gauge, wherein the yarns of the second gauge are parallel to each other, further wherein a difference in size between the yarns of the first gauge and the yarns of the second gauge provides slip resistance.

According to another embodiment, the method may further comprises the step of affixing a thermoplastic layer to at least one of a front side and a back side of the closed-weave woven for providing a weather-resistant barrier.

The following terms are defined below.

The term “slip resistant sheet material” is intended to mean a sheet material provided with an additional means for increasing the slip resistance and thereby increasing safety of those walking on roofs, or on any surfaces, on which the slip resistance sheet material is installed before installation of an overlayment.

The term “closed-weave woven” is intended to mean yarns or threads that are normally tightly interlaced at a right angle to form a fabric or a sheet material. The method in which these yarns or threads are interwoven affects the characteristics of the fabric or of the sheet material. The yarns or threads that are tightly interlaced may also be at an angle different than the right angle.

The term “thermoplastic layer” is intended to mean an elastic and flexible layer, made of a thermoplastic material, to be affixed to at least one of the front and back sides of a closed-weave woven. The “thermoplastic layer” may provide a weather-resistant barrier which prevents moisture and other external elements from passing through the slip resistant sheet material.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is an exploded, perspective view of the slip resistant sheet material for roofing in accordance with an embodiment;

FIG. 2 is an enlarged, fragmentary, cross-sectional view of the slip resistant sheet material for roofing of FIG. 1;

FIG. 3 is an elevation view of the closed-weave woven of the slip resistant sheet material for roofing in accordance with an embodiment;

FIG. 4 is an elevation view of the closed-weave woven of the slip resistant sheet material for roofing in accordance with an embodiment;

FIG. 5 illustrates a method for preparing a slip resistant sheet material for roofing in accordance with an embodiment; and

FIG. 6 is a perspective view of the slip resistant sheet material for roofing being installed on an exemplary roof structure in accordance with an embodiment; and

FIG. 7 is a perspective view showing the slip resistant sheet material for roofing of FIG. 6 in a later stage of the installation process.

It will be noted that throughout the appended drawings, like features are identified by like reference numerals.

### DETAILED DESCRIPTION

There is disclosed herein various embodiments of a slip resistant sheet material for roofing.

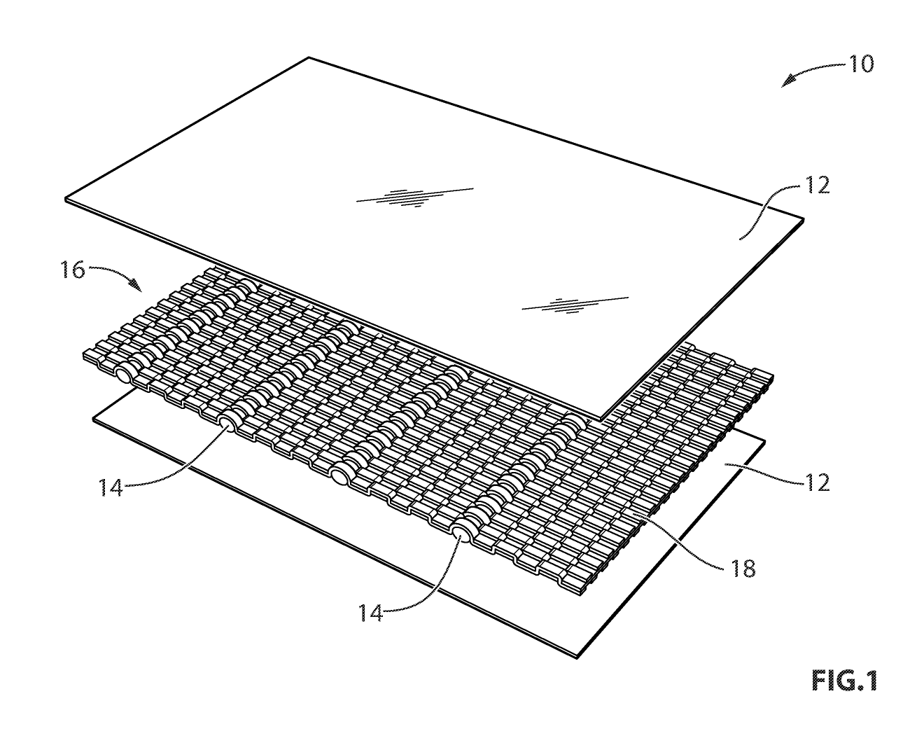

Referring now to the drawings, and more particularly to FIG. 1, there is shown an exploded, perspective view of a slip resistant sheet material for roofing 10 in accordance with an embodiment. The slip resistant sheet material for roofing 10 is made of a closed-weave woven 16. Normally, the closed weave woven 16 has yarns of a first gauge 18 in two directions. More preferably, the two directions taken by the yarns of a first gauge 18 are perpendicular. In one of the two directions, yarns of a first gauge 18 are replaced with yarns of a second larger gauge 14 at a regular interval. The difference in height between the yarns of the first gauge 18 and the yarns of the second gauge 14 provides an additional means for increasing the slip resistance and thereby increasing safety of those walking on roofs on which the slip resistance sheet material is installed before installation of the overlayment. In accordance with an embodiment, the yarns of a first gauge 18 are substantially flat, but can adopt any other cross-sectional configurations.

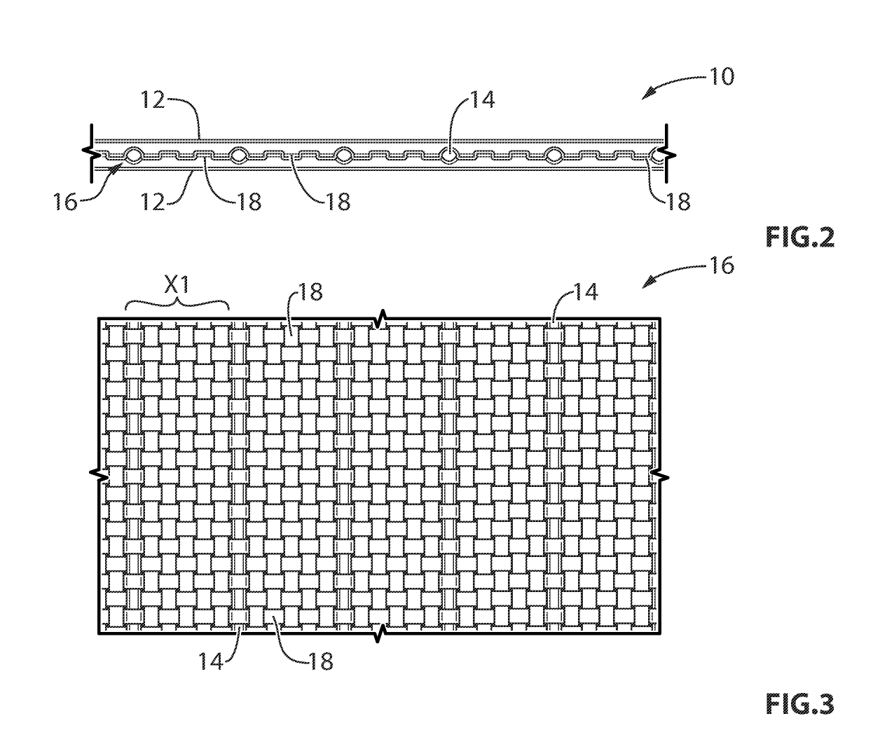

Referring now to FIG. 2, there is shown an enlarged, fragmentary, cross-sectional view of the slip resistant sheet material for roofing 10, in accordance with an embodiment. The slip resistant sheet material for roofing 10 includes a closed-weave woven 16 having a thermoplastic layer 12 affixed to at least one of its front and back sides. The thermoplastic layers 12 are normally affixed to both the front and the back sides of the closed-weave woven 16, as shown in the slip resistant sheet material for roofing 10 of FIGS. 1 and 2.

Still referring to FIGS. 1 and 2, the closed-weave woven 16 is formed of yarns of a first gauge 18 of material having a tensile strength sufficient to resist tearing when exposed to tensile loads from various directions. More specifically, the slip resistant material for roofing 10 includes a closed-weave woven 16, which includes yarns of a first gauge 18 and yarns of a second gauge 14 greater than the first gauge. The yarns of a second gauge 14 are interspersed in the closed-weave woven at a given interval with the yarns of the first gauge 18.

According to an embodiment, the yarns of the second gauge 14 of the closed-weave woven 16 are parallel to each other. In the closed-weave woven 16, the spacing between the parallel yarns of the second gauge 14 is substantially equal.

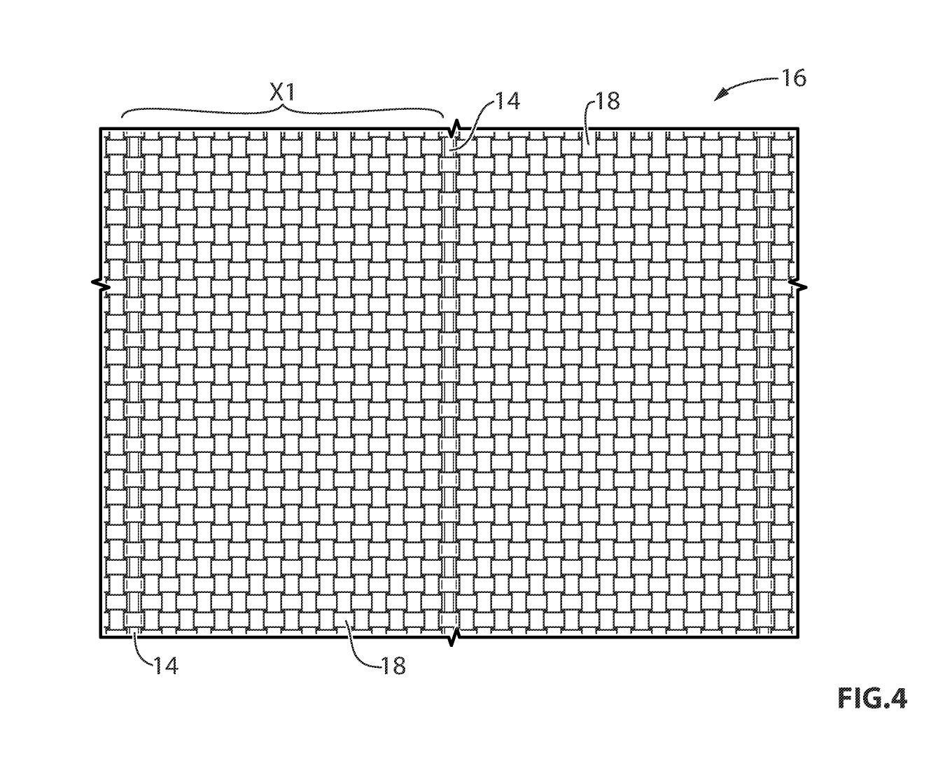

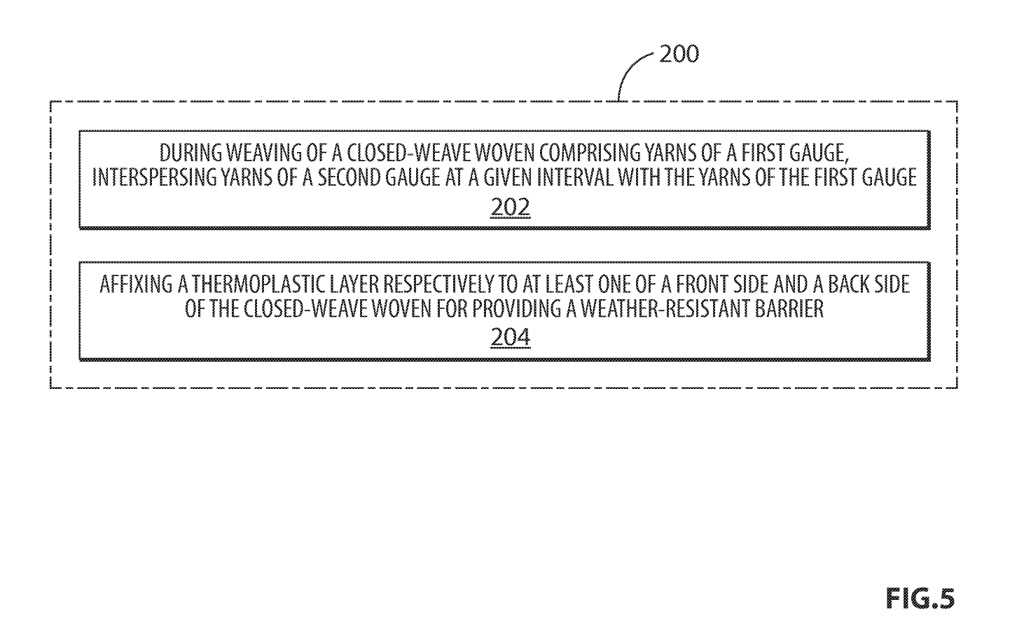

Referring now to FIGS. 3 and 4, there are shown elevation views of the closed-weave woven 16 of the slip resistant sheet material for roofing 10 in accordance with different embodiments. In FIGS. 3 and 4, a first group of yarns of the first gauge 18 are in a first direction, a second group of yarns of the first gauge 18 are in a second direction perpendicular to the first direction and a third group of yarns of the second gauge 14 are in the second direction perpendicular to the first direction. Also, the yarns of the second gauge 14 are interspersed at the given interval in one of the first and second directions for preventing a person from slipping while moving about on the slip resistant sheet material for roofing 10. It is to be noted that the given interval is a multiple of 6 yarns in an embodiment, as shown in FIG. 3 and referred to as X1. In another embodiment the multiple is 18 yarns, as shown in FIG. 4 and referred to as X2. However, according to different embodiments, the given interval may be a multiple of any suitable number.

According to an embodiment, the given interval may be a multiple of one of: 6 yarns, 18 yarns, 36 yarns, 72 yarns and 90 yarns.

According to another embodiment, the given interval may be a mix of at least two given intervals. For instance, for allowing a worker to walk on a roofing structure without sliding, the slip resistant sheet material for roofing 10 may include a first group of three yarns of the second gauge 14 interspersed at a given interval of 6 yarns of the first gauge 18 in the closed-weave woven 16 and another yarn of the second gauge 14, distant from the first group of three yarns of the second gauge 14, at another given interval of 72 yarns of a first gauge 18.

According to another embodiment, the given interval is one of: a regular given interval and an irregular given interval. As another example, a first group of three yarns of the second gauge 14 may intersperse the closed-weave woven 16 at a first quarter of the closed-weave woven 16, a second group of three yarns of the second gauge 14 may intersperse the closed-weave woven 16 at a first half of the closed-weave woven 16 and a third group of three yarns of the second gauge 14 may intersperse the closed-weave woven 16 at a second quarter of the closed-weave woven 16.

It is also to be noted that the yarns of a first gauge 18 are tightly interwoven. The yarns of a first gauge 18 of the closed-weave woven 16 may be formed of a thermoplastic polymer, such as polypropylene, polyethylene, polyester, nylon or other similar materials. However, it is to be noted that the yarns of a first gauge 18 of the closed-weave woven 16 may be of any suitable material that has strength sufficient to resist tearing when exposed to tensile loads from various directions.

The yarns of a first gauge 18 are interwoven as shown in FIG. 2, by way of example, to provide a closed-weave woven 16 having an improved tensile strength not achievable with solid film of material. The orientation of the yarns of a first gauge 18 may also be selected to optimize their tensile strength.

The yarns of a first gauge 18 and the yarn of a second gauge 14 may comprise any cross-sectional shape and size, depending upon the desired tensile characteristics of the closed-weave woven 16. For example, the yarns of a first gauge 18 may be interwoven fibers as shown in FIG. 2, may be cross-laminated polyethylene tape, or may include any other interwoven configuration. The size of the yarn of the first gauge 18 may be approximately 800 Denier to 1,000 Denier. The size of the yarn of the second gauge 14 may be between 1,000 Denier and 12,000 Denier. However, the size of the yarns of the first gauge 18 and the size of the yarns of the second gauge 14 may be of any suitable size allowing the formation of a tight closed-weave woven 16.

Referring to FIGS. 1 and 2, the thermoplastic layers 12 affixed to both sides of the closed-weave woven 16 provide a weather-resistant barrier which prevents moisture and other external elements from passing through the slip resistant sheet material for roofing 10. An exemplary embodiment for the thermoplastic layers 12 includes a layer of thermoplastic film which is extruded over each side of the closed-weave woven 16, so that the closed-weave woven 16 is sandwiched between the two thermoplastic layers 12.

The slip resistant sheet material for roofing 10 is shown as having a thermoplastic layer 12 positioned over each side of the closed-weave woven 16. However, it is understood that certain applications may allow the closed-weave woven 16 to have only one side or none of its sides coated with a thermoplastic layer 12. The thermoplastic layer 12 may include polyethylene, polypropylene, or other similar thermoplastic polymers.

The slip resistant sheet material for roofing 10 is formed by extruding layers of thermoplastic layer 12 over the closed-weave woven 16, but it is understood that the thermoplastic layers 12 may be affixed to the closed-weave woven 16 using an adhesive or any other manner of attachment.

The thermoplastic layers 12 may be variably pigmented to allow the color of the thermoplastic layers 12 to be selected based upon particular requirements. The thickness of the thermoplastic layers 12 is selected such that the slip resistant sheet material for roofing 10 is flexible, whereby the flexible nature of the slip resistant sheet material for roofing 10 allows it to be formed into rolls and easily installed by simply unrolling the slip resistant sheet material for roofing 10 over a roof support structure or the like.

The slip resistant sheet material for roofing 10 may be installed between a roof support structure and an overlayment in order to provide a waterproof barrier for the roof structure. The slip resistant sheet material for roofing 10 may be mechanically fastened to the roof rafters using nails or screws, but it is understood that the slip resistant sheet material for roofing 10 may be affixed to the roof rafters using adhesives or other possible attachment methods.

The slip-resistant sheet material for roofing 10 may be formed from a plurality of thermoplastic layers 12 having an improved resistance to deterioration from exposure to external elements, such as moisture and dirt, so that the slip resistant sheet material for roofing 10 has an improved durability and longevity. Moreover, employing closed-weave woven 16 including yarns of a second gauge 14 in the slip resistant sheet material for roofing 10 provides an improved tensile strength capable of being walked upon without tearing when being installed on the roof. The closed-weave woven 16 further provides improved strength to resist tearing when exposed to external forces, such as collected moisture, wind, and other external forces.

As shown, the improved resistance to deterioration and tearing provided by the slip resistant sheet material for roofing 10 improves the integrity and effectiveness of the weather-resistant barrier provided by the slip resistant sheet material for roofing 10. By improving the longevity of the waterproof integrity of the slip resistant sheet material for roofing 10 to more closely match the integrity of the entire roof structure, the longevity of the integrity of the entire roof structure is improved.

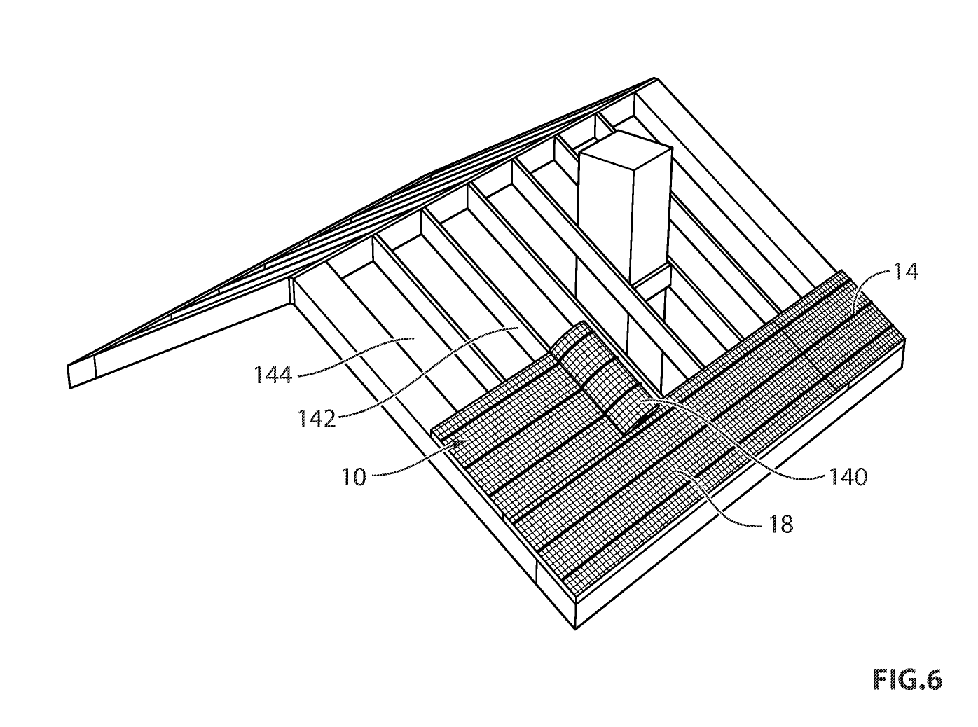

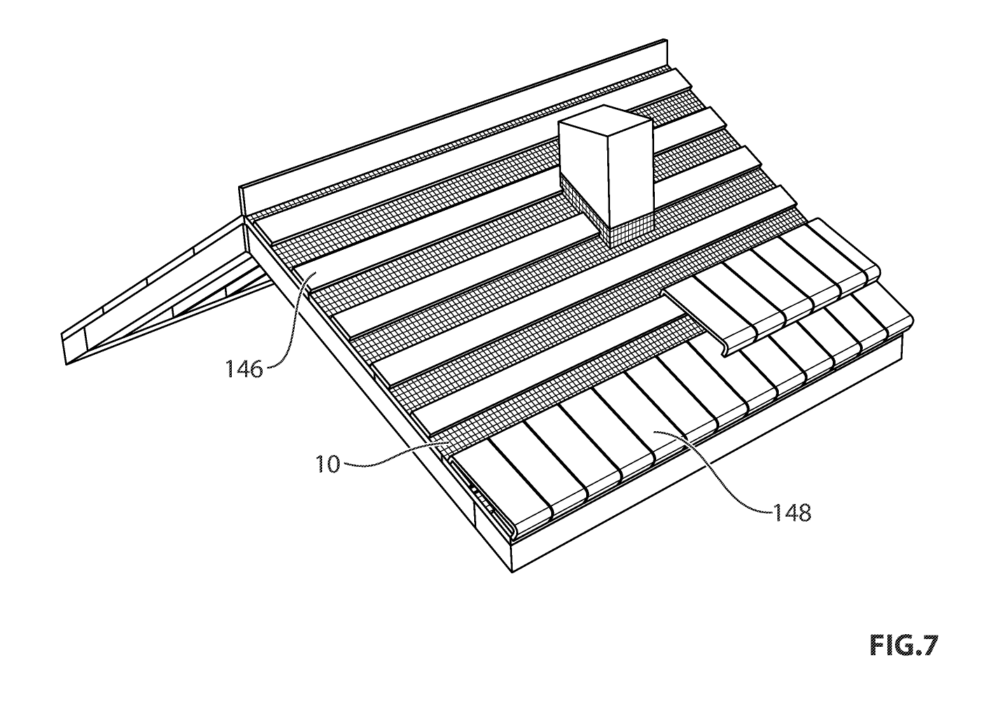

According to an embodiment, and referring now to FIG. 6, there is shown a perspective view of the slip resistant sheet material for roofing 10 being installed on an exemplary roof structure in accordance with an embodiment. The slip resistant sheet material for roofing 10 is to be installed between a roof support structure and an overlayment in order to provide a waterproof barrier and a slip resistant material for the roof structure. As shown, the slip resistant sheet material for roofing 10 may be formed into rolls 140 which can be simply unrolled over the roof support 142 to allow for easy installation. In this exemplary roof structure, the sarking method is utilized where the slip resistant sheet material for roofing 10 is fastened to the top side of the roof rafters 142 and allowed to drape between the open rafters bays 144. The slip resistant sheet material for roofing 10 is preferably mechanically fastened to the roof rafters 142 using nails or screws, but it is understood that the slip resistant sheet material for roofing 10 may be affixed to the roof rafters 142 using another adhesives or other possible attachment methods.

Battens 146 are then fastened over the slip resistant sheet material for roofing 10 and into the top side of the roof rafters 142, where the overlayment 148 is then attached to the battens 146, as shown in FIG. 7. The sarking method is merely one possible manner of installing a roof structure using the slip resistant sheet material for roofing 10. For instance, the roof supports 142 on which the slip resistant sheet material for roofing 10 is attached may include solid sheathing or spaced sheathing. Further, any type of batten structure may be attached to the slip resistant sheet material for roofing 10 for supporting the overlayment 148, such as wood battens, steel battens, plastic battens, counter-battens made from any of these materials, or the overlayment 148 may be attached directly to the roof support 142 through the slip resistant sheet material for roofing 10.

According to another embodiment, there is provided a method 200 for preparing a slip resistant sheet material for roofing 10. The method for preparing a slip resistant sheet material for roofing 10 comprises the step 202 of, during weaving of a closed-weave woven 16, comprising yarns of a first gauge 18, interspersing yarns of a second gauge 14 at a given interval with the yarns of the first gauge 18, wherein the yarns of the second gauge 14 are parallel to each other. Also, a difference in size between the yarns of the first gauge 18 and the yarns of the second gauge 14 provides slip resistance.

The method 200 for preparing a slip resistant sheet material for roofing 10 may further comprise the step 204 of affixing a thermoplastic layer 12 to at least one of a front side and a back side of the closed-weave woven 16 for providing a weather-resistant barrier.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A slip resistant sheet material for roofing comprising:
a closed-weave woven comprising:
yarns of a first gauge; and
yarns of a second gauge greater than the first gauge, the yarns of the second gauge interspersed in the closed-weave woven at a given interval with the yarns of the first gauge;
wherein a difference in size between the yarns of the first gauge and the yarns of the second gauge provides slip resistance.

2. The slip resistant sheet material for roofing of claim 1, wherein the yarns of the second gauge are parallel to each other.

3. The slip resistant sheet material for roofing of claim 2, wherein spacing between the yarns of the second gauge is substantially equal.

4. The slip resistant sheet material for roofing of claim 2, wherein the yarns of the first gauge are organized in a first group in a first direction and in a second group in a second direction perpendicular to the first direction.

5. The slip resistant sheet material for roofing of claim 4, wherein yarns of the second gauge are interspersed at the given interval in one of the first and second groups.

6. The slip resistant sheet material for roofing of claim 5, wherein all yarns of the second gauge are interspersed at the given interval in one of the first and second groups.

7. The slip resistant sheet material for roofing of claim 5, wherein the given interval is a multiple of 6 yarns.

8. The slip resistant sheet material for roofing of claim 5, wherein the given interval is a multiple of 18 yarns.

9. The slip resistant sheet material for roofing of claim 5, wherein the given interval is a multiple of one of: 6 yarns, 18 yarns, 36 yarns, 72 yarns and 90 yarns.

10. The slip resistant sheet material for roofing of claim 9, wherein the given interval is a mix of at least two given intervals.

11. The slip resistant sheet material for roofing of claim 5, wherein the given interval is one of: a regular given interval and an irregular given interval.

12. The slip resistant sheet material for roofing of claim 1, wherein the closed-weave woven comprises a front side and a back side, the slip resistant sheet material further comprising at least one thermoplastic layer respectively affixed to at least one of the front side and the back side of the closed-weave woven for providing a weather-resistant barrier.

13. The slip resistant sheet material for roofing of claim 12, wherein the at least one thermoplastic layer is a film-forming polymer.

14. The slip resistant sheet material for roofing of claim 12, wherein the at least one thermoplastic layer may include polyethylene or polypropylene.

15. The slip resistant sheet material for roofing of claim 1, wherein the yarns of a first gauge comprise a size approximately from about 800 Denier to about 1,000 Denier.

16. The slip resistant sheet material for roofing of claim 1, wherein the yarns of a second gauge comprise a size approximately from about 1,000 Denier to about 1,200 Denier.

17. The slip resistant sheet material for roofing of claim 1, wherein the yarns of a first gauge are substantially flat.

18. A method for making a slip resistant sheet material for roofing, the method comprising:
during weaving of a closed-weave woven comprising yarns of a first gauge, interspersing yarns of a second gauge at a given interval with the yarns of the first gauge, wherein the yarns of the second gauge are parallel to each other, further wherein a difference in size between the yarns of the first gauge and the yarns of the second gauge provides slip resistance.

19. The method of claim 18, further comprising the step of affixing a thermoplastic layer to at least one of a front side and a back side of the closed-weave woven for providing a weather-resistant barrier.
